(19) United States
(12) Patent Application Publication
(10) Pub. No.: US 2026/0024241 A1
(43) Pub. Date: Jan. 22, 2026

(54) System and Method for Event-Driven Video Synthesis Using Textual Descriptions

(71) Applicant: The University of Hong Kong, Hong Kong (CN)

(72) Inventors: Yaping ZHAO, Hong Kong (CN); Pei ZHANG, Hong Kong (CN); Chutian WANG, Hong Kong (CN); Yin Mun Edmund LAM, Hong Kong (CN)

(73) Assignee: The University of Hong Kong, Hong Kong (CN)

(21) Appl. No.: 19/271,684

(22) Filed: Jul. 16, 2025

Related U.S. Application Data
(60) Provisional application No. 63/673,513, filed on Jul. 19, 2024.

(51) Int. Cl. G06T 11/00; G06T 5/70; G06T 13/00

(52) U.S. Cl. CPC G06T 11/00; G06T 5/70; G06T 13/00; G06T 2207/10016; G06T 2207/10024; G06T 2210/32

(57) ABSTRACT

A video generation framework that is controllable, unsupervised and based on events (CUBE) includes an event camera, which captures changes in light intensity at each pixel of a scene asynchronously and generates event camera data. A text-to-image diffusion model that is conditioned on textual descriptions integrates the event camera data to control video synthesis. Further, an edge extraction module translates event data into a format usable by the text-to-image diffusion model, whereby the diffusion model synthesizes detailed and contextually accurate videos based on textual prompts. Further, an improved system (CUBE Plus) includes a content frame identification module which selectively identifies and uses only the most information-rich event segments of the event camera data to drive cross-frame attention, and an event driven attention mechanism that allows the framework to focus on event-dense moments.

### CROSS-REFERENCE TO RELATED PATENT APPLICATIONS

This application claims the benefit of priority under 35 U.S.C. Section 119 (e) of U.S. Application No. 63/673,513 filed Jul. 19, 2024, which is incorporated herein by reference in its entirety.

### FIELD OF THE INVENTION

The present invention relates to the generation of videos using event-driven data from event cameras and textual descriptions.

### BACKGROUND OF THE INVENTION

Traditional video generation techniques typically require extensive datasets and prolonged training periods to produce high-quality results. These prior systems struggle to efficiently incorporate real-time, dynamic inputs such as those from event cameras. Additionally, current methods often lack the ability to control the video output in a meaningful way based on textual or other high-level descriptions, limiting their utility in applications requiring specific content generation.

Event cameras, inspired by biological vision, represent a new type of sensor that reacts to brightness changes within a scene [6]. Unlike conventional cameras, which record frames at fixed intervals as shown in FIG. 2A, event cameras operate asynchronously and detect changes at the pixel level with timestamps as shown in FIG. 2B. This functionality offers several advantages: (i) sparsity, as only brightness changes are recorded; (ii) high temporal resolution, capturing movements at microsecond intervals; and (iii) high dynamic range, making event cameras more robust in both low-light and high-contrast scenes. These qualities allow event cameras to capture fast and dynamic motions more efficiently and accurately than frame-based sensors, excelling in applications involving rapid movement or challenging lighting conditions, such as autonomous driving, sports, surveillance, and robotics [4,45,46,50,51,59].

The advent of event cameras, with their unique asynchronous sensing ability to capture the edge details of moving objects, has sparked new directions in video generation. So far, the challenge of integrating event-based data for controllable video generation remains largely unexplored.

An “event” in the context of event-based imaging systems, particularly with event cameras, refers to a change in the intensity of light at a pixel level that exceeds a predefined threshold. Unlike traditional cameras that capture full frames at regular intervals, event cameras record data only when there is a change in the scene, thereby producing events. Each event is characterized by the pixel's location, the exact time of occurrence, and the polarity of change (increase or decrease in intensity).

Despite these benefits, event cameras pose challenges. Without absolute intensity values, they capture limited visual details, lacking textures and colors for intuitive interpretation. As a result, the alignment with human perception and realism is compromised. This limitation has spurred research in event-based video reconstruction, as shown in FIG. 2C. However, traditional approaches [2, 8, 15, 17, 40, 53, 54] suffer noise accumulation, visual artifacts, and unclear edges. More recent methods integrating diffusion models [26, 27, 29,30, 52, 56, 57] into existing reconstruction frameworks [19, 49] offer incremental improvements but require extensive training datasets, prolonged training periods, and substantial computational resources.

Event-based video generation offers an alternative, synthesizing visually enriched content rather than strictly reconstructing it from sparse and noisy event data. The key insight is leveraging event cameras to capture motion dynamics while allowing users to define appearance, textures, and backgrounds. This not only enhances controllability but also expands potential applications, such as augmented reality/virtual reality (AR/VR) and creative arts.

Traditional event-based video reconstruction methods [2, 8, 12, 15, 17, 39, 40, 53, 54] relied on optimizing or integrating event data, but often produced rigid and unrealistic results, limited to simple motions or controlled scenes. With the advent of artificial intelligence deep learning, neural networks like U-Net [55], recurrent network [11], transformer [14], and spiking neural network [66] enabled more nuanced reconstructions, capturing complex patterns from event data. Generative models, particularly diffusion models [26, 27, 29, 30, 52, 56, 57], marked further progress by sampling from distributions of possible reconstructions, achieving more realistic and varied outputs through probabilistic modeling [19, 49]. However, limitations remain due to the inherent characteristics of event cameras. Their sensitivity to scene changes make them susceptible to noise, which degrades reconstruction quality, particularly in low-light conditions (see FIG. 2A). Furthermore, since event cameras capture only motion without texture details, exploring event-based video generation that uses events as input offers a promising path. This approach could capitalize on the motion-detecting strengths of event cameras while allowing customizable and realistic video generation—an area still largely unexplored At the forefront of computational neuromorphic imaging (CNI) the focus is currently on seamlessly integrating the physical imaging process with the event-driven modality to enhance efficiency [2, 3, 4, 5]. The capability of CNI to selectively capture the edge information of moving objects, while reducing bandwidth by discarding unnecessary visual data, is noteworthy. CNI with event cameras is characterized by several advantages including high dynamic range (HDR), superior temporal resolution, and low energy consumption. These attributes render CNI highly effective for specific applications in HDR environments and high-speed motion capture scenarios [6].

However, the inherent sparsity and asynchronous nature of event streams present a challenge in recording absolute scene intensity, thus limiting their capacity for intuitive and natural visualization of detailed scene information. Consequently, events fall short in terms of perceptual realism. Fortunately, the event stream encapsulates a condensed form of visual data, furnishing essential elements for image or video reconstruction [7, 8, 9]. A common practice involves reconstructing images from the event stream. Unfortunately, existing methods either exhibit limited performance [10, 11, 12, 13, 14, 15] or require extensive ground truth frames for neural network training [16, 17, 18, 19]. Recent studies have delved into the application of diffusion models for image generation. Despite these advancements, the reconstruction quality substantially lags the standards of photo-realistic videos, particularly in synthesizing individual frames independently, and suffers in training requirements. Additionally, the outcomes generated by previous methods lack controllability and cannot be guided by high-level semantic information provided by users to create specific scene content.

Diffusion models [26, 27, 28, 29, 30] have emerged as popular research models in computer vision, demonstrating impressive capabilities in image generation. Inspired by non-equilibrium thermodynamics, these models evolved from denoising diffusion probability models (DDPMs) [26, 28]. The latent diffusion model (LDM) [27] is an efficient variant of diffusion models that applies the diffusion process in the latent space instead of the image space. LDM consists of two main components.

First, it employs an encoder ε to compress an image x into a latent code z=ε(x) and a decoder to reconstruct the image x≈D(z). Second, it learns the distribution of image latent codes using a DDPM formulation [26], which includes a forward and a backward process. The forward diffusion process gradually adds Gaussian noise at each timestep t to obtain zₜ:

$$q ( {z}_{t} \vert {z}_{t - 1} ) = 𝒩 ( {z}_{t} ; \sqrt{1 - {β}_{t}} {z}_{t - 1} , {β}_{t} I ) , \qquad ( 1 )$$

where

$${\{ {β}_{t} \}}_{t = 1}^{T}$$

are the scale of noises, und T denotes the number of diffusion timesteps. The backward denoising process reverses the diffusion process to predict less noisy zₜ₋₁:

$${p}_{θ} ( {z}_{t - 1} \vert {z}_{t} ) = 𝒩 ( {z}_{t - 1} ; {μ}_{θ} ( {z}_{t} , t ) , {\sum }_{θ} ( {z}_{t} , t ) ) . \qquad ( 2 )$$

The are μ_{θ} and Σ_{θ} implemented using a denoising model ϵ_{θ} with learnable parameters θ, which is trained with a simple objective:

$${ℒ}_{simple} := {𝔼}_{ℰ ( z ) , ϵ \sim 𝒩 ( 0 , 1 ) , t} [ {‖ ϵ = {ϵ}_{θ} ( z , t ) ‖}_{2}^{2} ] . \qquad ( 3 )$$

During the generation of new samples, the method starts from Z_{T}˜(0,1) and employs DDIM sampling to predict Zₜ−1 at the previous timestep:

$${z}_{t - 1} = \sqrt{{α}_{t - 1}} {z}^{′} + \sqrt{1 - {α}_{t - 1}} \cdot {ϵ}_{θ} ( {z}_{t} , t ) , \qquad ( 4 )$$

$${z}^{′} = \frac{{z}_{t} - \sqrt{1 - {α}_{t}} {ϵ}_{θ} ( {z}_{t} , t )}{\sqrt{{α}_{t}}} ,$$

$$where$$

$${α}_{t} = {\prod }_{i = 1}^{t} ( 1 - {β}_{i} ) ,$$

The expression z_{t→0} is used to represent the “predicted z₀” at timestep t for simplicity. Stable Diffusion (SD) ϵ_{θ}(Zₜ, t, τ) is used as the base model, which is an instantiation of text-guided LDMs pre-trained on billions of image-text pairs. Here, t represents the text prompt.

ControlNet [31] and ControlVideo [22] have expanded the scope of text-to-image and text-to-video generation to include varied input conditions like depth maps, poses, scribbles, and edges.

Despite these advancements, the incorporation of events as input conditions for generating video remains largely unexplored.

### SUMMARY OF THE INVENTION

To overcome the limitations of the prior art, the present invention proposes a training-free event-guided video generation framework that requires only minimal prompts to shape the appearance, background, and texture of generated scenes as shown in FIG. 1A, FIG. 1B and FIG. 2D. This approach directly leverages the intrinsic properties of event data to drive and enhance video generation. Specifically, the event data is used to identify content frames within the generation pipeline and to design an event driven attention mechanism that selectively focuses on these sparse yet informative frames, improving both video quality and computational efficiency. This enables applications such as outdoor nighttime live streaming for virtual avatars and wildlife documentary filming and editing, as shown in FIGS. 3A-3C.

In one embodiment the present invention integrates an edge extraction module with ControlVideo, enabling the reconstruction of videos from events. According to the invention a framework is introduced that leverages edge information extracted from events with pre-trained text-to-image models and combines it with textual descriptions to synthesize high-quality videos without the requirement of extensive training. The framework utilizes event-based video generation using diffusion models.

The invention leverages the capabilities of event cameras to capture high-resolution temporal information and integrate it with semantic guidance from text inputs to dynamically generate contextually relevant and visually coherent video sequences.

This present invention solves the problems of prior systems by introducing a combination of neuromorphic (artificial intelligence) computing and diffusion model techniques. It employs an edge extraction module to transform sparse, asynchronous event data into a structured format that is then processed using a modified diffusion model conditioned on textual descriptions. This approach not only significantly reduces the need for large training datasets and computational resources but also enhances the ability to produce videos that are directly influenced by user-provided text, enabling precise control over the content generated.

This system represents both a new use of event camera data for video synthesis and a significant improvement over existing processes for video generation. It advances the state-of-the-art by:
Enabling real-time video generation that responds dynamically to textual inputs.
Reducing the dependency on extensive pre-training and large datasets.
Enhancing the quality and relevance of generated video content.
   These improvements make it particularly suited for applications in real-time surveillance, interactive gaming, and dynamic content creation for virtual reality. The main contributions of the present invention are:
1. An event-guided framework that controls diffusion models for video generation from event data without training. This is the first technique to leverage the inherent characteristics of event data to optimize the video generation process.
2. An event-driven attention mechanism, coupled with efficient and effective content frame identification.
3. A diverse dance dataset collected under various lighting conditions using event cameras, fostering advancements in areas like sports analysis and pose estimation.
4. Extensive validation across multiple datasets, showing superior temporal consistency and controllability

As a result, with the present invention, event camera data, which captures changes in light intensity at each pixel asynchronously, is used as a primary input for video generation. This data is integrated with a diffusion model that is conditioned on textual descriptions to control video synthesis; an approach not previously applied in existing systems. An edge extraction module that translates event data into a format usable by text-to-image diffusion models, enables the synthesis of detailed and contextually accurate videos based on textual prompts. These elements collectively represent a significant advancement in the field of computational imaging and video synthesis, providing enhanced capabilities that are not evident in existing technologies.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A shows event input data and FIG. 1B shows a set of screen shots of exemplary videos of a young man created in an event-guided controllable video generation framework, in which content frame identification and an event-driven attention mechanism are devised to produce smooth and coherent video frames that convey realistic textures and vibrant colors given events as input, without the need for training;

FIG. 2A shows how standard cameras fail to capture discernible images in low-light conditions, FIG. 2B shows how event cameras effectively capture scene changes in the dark, FIG. 2C shows how event-based reconstruction suffers in unclear edges and blurred textures due to the noise accumulation, and FIG. 2D shows an output of the present invention employing noisy events to generate high-quality videos;

FIG. 3A shows how standard cameras struggle in challenging lighting, FIG. 3B shows how event cameras capture motion dynamics, and FIG. 3C shows how the method of the present invention enables night sports broadcasting and wildlife filming;

FIG. 4 is a flow chart of the operation of a video generation framework, i.e., a Controllable, Unsupervised, Based on Events (CUBE) system according to the present invention;

FIG. 5 is a display of raw event data, where ‘x’ and ‘y’ represent spatial coordinates, ‘t’ denotes the time dimension and the red and blue colors of the pixel dots indicate increased or decreased intensity, respectively;

FIG. 6 is a diagram of the CUBE framework where the left of the diagram shows CUBE generating videos conditioned on the edge information extracted from events using diffusion models and the right shows CUBE synthesizing various photo-realistic videos given different textual descriptions;

FIG. 7 shows qualitative comparisons of CUBE, the present invention, outperforming other methods of video generations in terms of video quality, temporal consistency, and textual alignment;

FIG. 8 shows additional qualitative comparisons of the present invention CUBE outperforming other methods in terms of video generation in terms of video quality, temporal consistency, and textual alignment;

FIG. 9 shows further qualitative comparisons showing that CUBE outperforms other methods;

FIG. 10 shows still more qualitative comparisons showing CUBE outperforming other methods;

FIG. 11A shows a visualization of event data and the challenges in event-based video generation by an event slice from a real-world dance sequence, showing pixel changes only in motion areas, leading to flickering, FIG. 11B shows the sparsity and discontinuity limitations of event data for video generation, FIG. 11C is an example of an object vanishing in the CUBE system and FIG. 11D shows an example of texture bleeding in a CUBE system;

FIG. 12 is a framework overview of a CUBE Plus system with a given an input event stream,

FIG. 13A illustrates first/former frame attention, FIG. 13B illustrates fully cross-frame attention, FIG. 13C illustrates content words in natural language processing and FIG. 13D illustrates content frame attention;

FIG. 14 illustrates the event-driven attention mechanism of the present invention;

FIG. 15A shows a DAVIS346 event camera for creating an EDance dataset, FIG. 15B shows a long dance sequence under low-light conditions, FIG. 15C shows event streams that illustrate the spatial-temporal event density, and FIG. 15D shows event slices that highlight the diversity of dance styles and dancer attire;

FIG. 16 shows qualitative comparisons of bird images on the Vimeo data set;

FIG. 17 shows qualitative comparisons on the challenging EDance dataset with event data under low-light conditions; and

FIG. 18 shows qualitative comparisons on the EventVOT dataset.

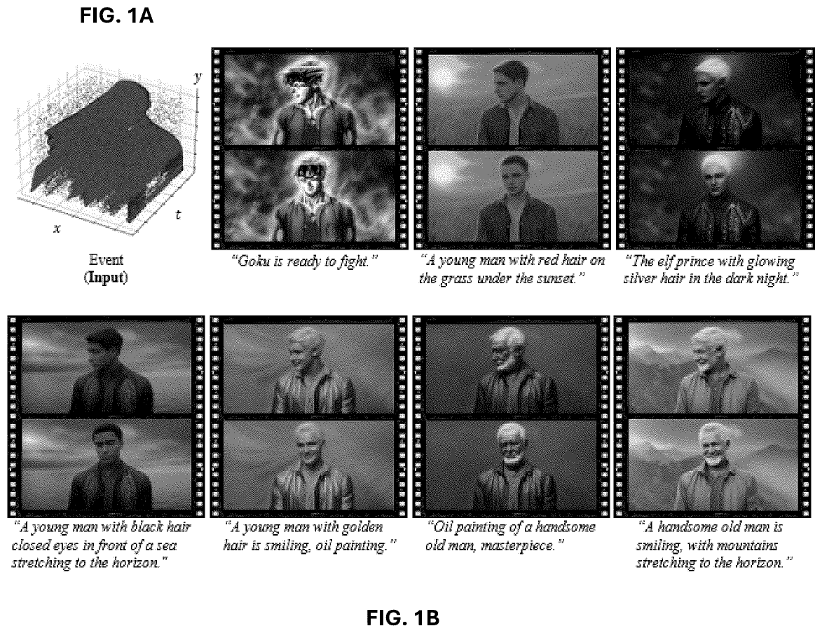

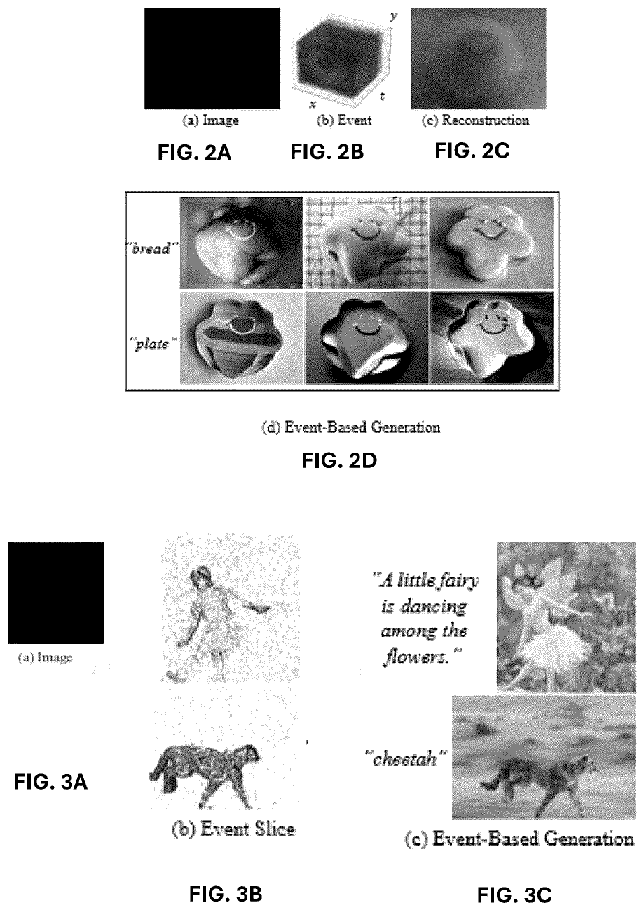

### DETAILED DESCRIPTION OF THE INVENTION

ControlVideo is a training-free framework that enables natural and efficient text-to-video generation. ControlVideo was adapted from ControlNet and it leverages coarsely structural consistency from input motion sequences and introduces three modules to improve video generation. First, to ensure appearance coherence between frames, ControlVideo adds fully cross-frame interaction in self-attention modules. Second, to mitigate the flicker effect, it introduces an interleaved-frame smoother that employs frame interpolation on alternated frames. Finally, to produce long videos efficiently, it utilizes a hierarchical sampler that separately synthesizes each short clip with holistic coherency. [22]

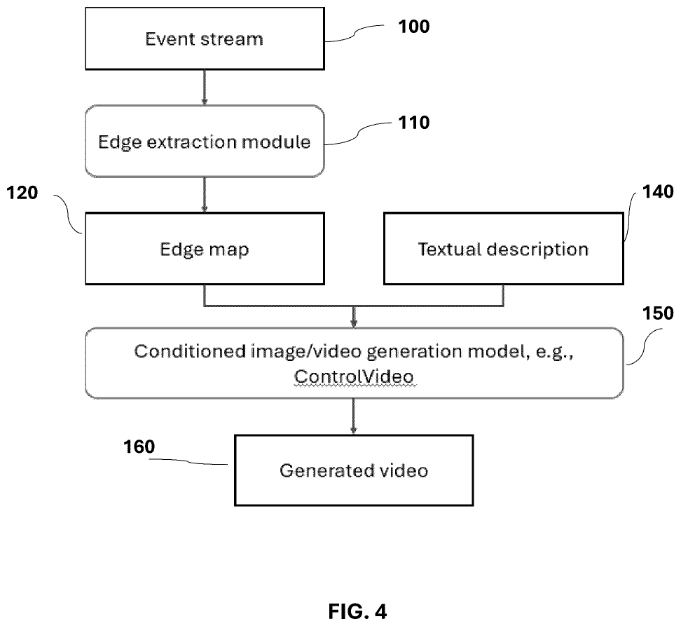

As indicated in FIG. 4 the system of the present invention, a Controllable, Unsupervised, Based on Events (CUBE) system, utilizes an event stream 100 obtained from

$$ε = {\{ {e}_{i} \}}_{i = 1}^{N}$$

an event camera denoted as, where N eᵢ ∈|ε is the number of events. Here, each event is represented by a tuple (xᵢ, yᵢ, sᵢ, pᵢ), where x and y represent the spatial position, s represents the timestamp, and P=±1 represents the polarity of the event.

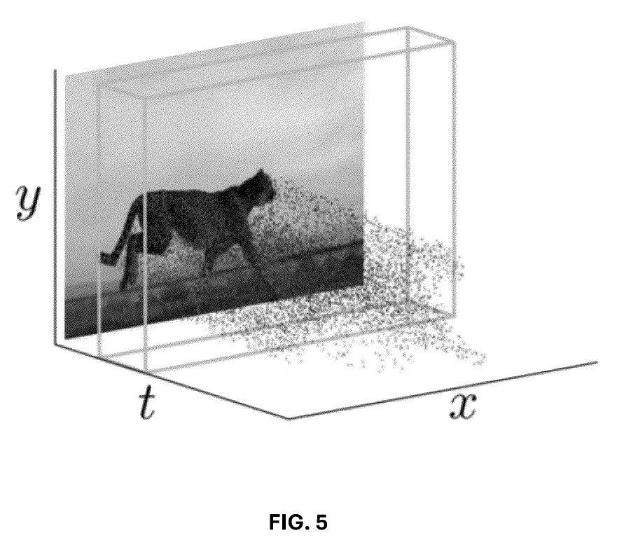

In the event visualizations shown in FIG. 5, increases in intensity are represented in red and decreases in blue. This method of capturing data generates a stream of events that offers highly efficient and detailed temporal resolution of dynamic scenes, focusing solely on areas where motion or light changes occur. This approach drastically reduces data redundancy and power consumption, making event cameras particularly effective in scenarios that demand high-speed and high-dynamic range imaging.

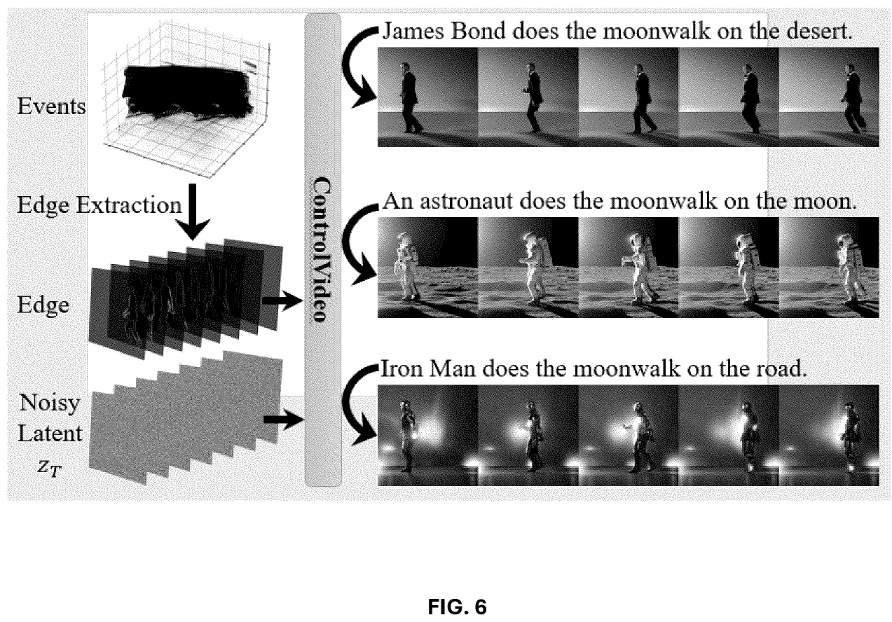

It should be noted that the images in FIG. 6 listed as “events” do not represent traditional images or video frames but are rather a representation of accumulated events over time, showing where changes have occurred in the scene. This visualization can sometimes be mistaken for an edge-like image because only changes (edges) trigger events, not static regions. However, an event stream captures temporal information much more granularly than a video and with far less data than full video frames, focusing purely on the changes in the scene without traditional image attributes like color. FIG. 5 displays the raw event data, where ‘x’ and ‘y’ represent the spatial coordinates, and ‘t’ denotes the time dimension. The two colors of event pixels in FIG. 5 (red for increase and blue for decrease) indicate two polarities of a stream of events from within the light blue cuboid visualized on a two-dimensional plane to produce the image-like representation. Additionally, an edge extraction method is employed to derive the edge image.

To facilitate the integration of event stream ε with ControlVideo, an edge extraction module 110 is used to convert events into edges. FIG. 4. For synthesizing V video frames, ε is V bins εⱼ∈_{[1,V]}. segmented into each holding n events. Then, the edge map 120 is extracted using the following equation:

$${I}_{j ∈ [ 1 , V ]} ( x , y ) = {\sum }_{i , {e}_{i} ∈ {s}_{j}} \frac{\vert {p}_{i} \vert δ ( x - {x}_{i} ) δ ( y - {y}_{i} )}{N} , \qquad ( 5 )$$

resulting in an intensity I∈[0,1]^{H×W×1} image with H and W representing height and width, respectively. Here, δ( ) is defined as the Kronecker delta function.

The approach to controllable event-based video generation aims to produce a V-length video, leveraging both the extracted edge information I and a textual prompt t from Textual description 140. These inputs to CUBE 150 allow it to generate video 160.

As depicted in FIG. 6, CUBE 150, is a training-free framework adapted from ControlVideo [22] and augmented with a specially designed edge extraction module so as to provide consistent and efficient video generation. In alignment with ControlVideo, first the clean video latent Z_{t→0} from Zₜ is estimated using the formula:

$${z}_{t \to 0} = \frac{{α}_{t} - \sqrt{1 - {α}_{t}} {ϵ}_{θ} ( {z}_{t} , t , I , τ )}{\sqrt{{α}_{t}}} . \qquad ( 6 )$$

Following ControlVideo [22], after mapping z_{t→0} to an RGB video X_{t→0}=D(Z_{t→0}), it is refined to a smother version x_{t→0} by employing the interleaved-frame technique from RIFE [32]. The smoother video \tilde{z}_{t→0}=ε(\tilde{x}_{t→0}) latent is then used to deduce a less noisy latent zₜ₋₁, following the DDIM denoising process as outlined in Eq. 4:

$${z}_{t - 1} = \sqrt{{α}_{t - 1}} {z}_{t \to 0} + \sqrt{1 - {α}_{t - 1}} \cdot {ϵ}_{0} ( {z}_{t} , t , I , τ ) . \qquad ( 7 )$$

In order to demonstrate the capability of the present invention, experiments were conducted in which short videos were synthesized with lengths of either 7 or 15 frames, and longer videos comprised approximately 100 frames, all rendered at a spatial resolution of 256×448. DDIM sampling techniques [30] with 50 timesteps were used for this process. Thanks to the efficient architecture of xFormers [33], the CUBE framework efficiently generated videos of both 7-frame and 100-frame lengths in about 0.5 and 5 minutes, respectively, using a single NVIDIA RTX 4090.

For a comprehensive evaluation of CUBE, 35 object-centric videos were collected from the Vimeo90K dataset [34], and V2E was utilized to generate events. To the right in FIG. 6 the text prompts and video clips are shown. The three textual prompts were written for each event, resulting in a dataset of 105 event-prompt pairs for testing. Following the teachings in [36, 37, 22], a CLIP [38] was adopted to evaluate the video quality from two perspectives: (a) frame consistency, measured by the average cosine similarity across consecutive frame pairs, and (b) prompt consistency, measured through the average cosine similarity between the input prompt and all video frames.

The framework CUBE was benchmarked against two event-based reconstruction approaches, CF [39] and E2VID [10, 40], and compared with recent generative methods, ControlNet [31] and ControlVideo [22]. Since the original versions of ControlNet and ControlVideo do not support events as input, these systems were modified to create comparable variants for a fair comparison, the results of which are discussed below.

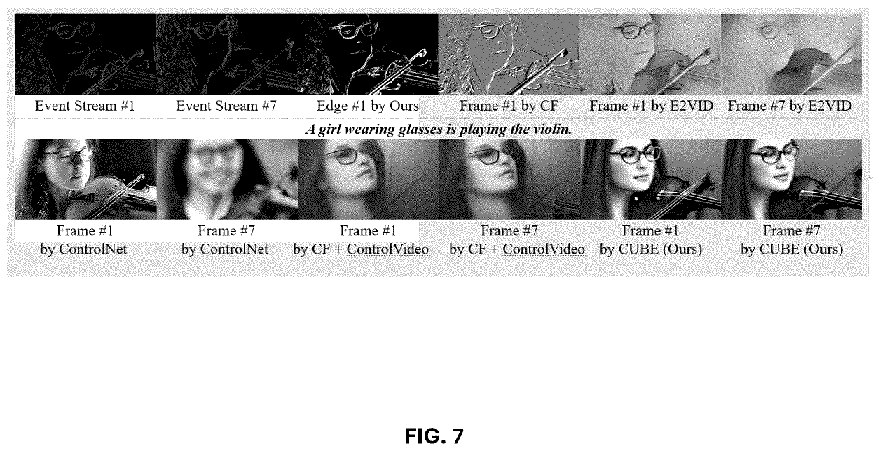

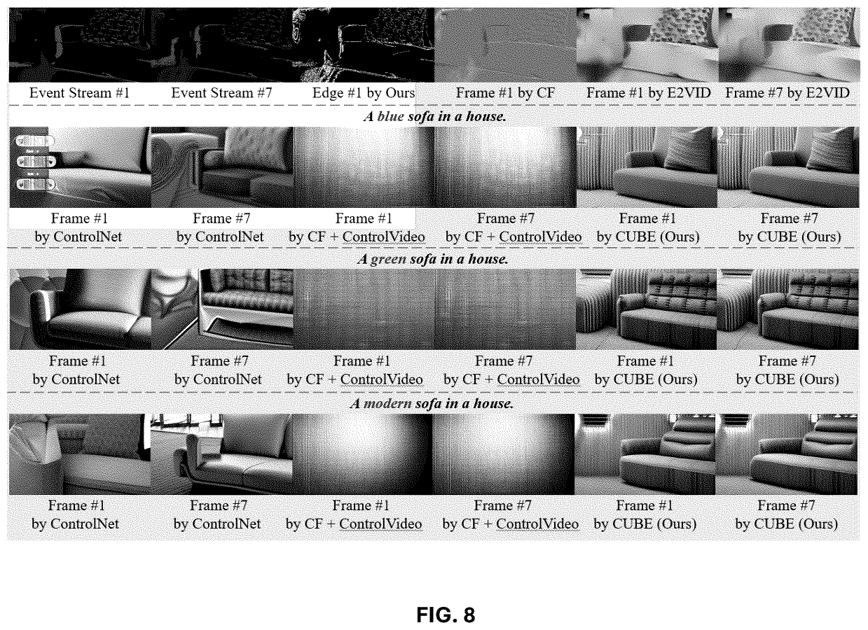

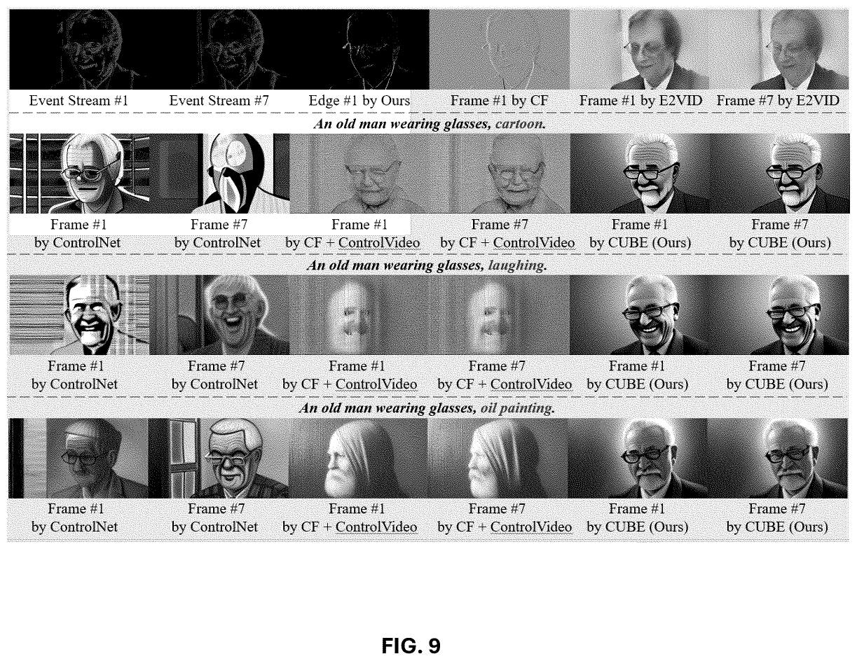

FIG. 6, FIG. 7, FIG. 8 and FIG. 9 illustrate the visual comparisons of synthesized videos by various methods. As observed in FIG. 7, the independent frame synthesis approach using ControlNet leads to a lack of temporal consistency; while ControlVideo maintains temporal coherence, it fails in generating a violin. Note that the top row of FIG. 7 shows event streams #1 and #7, an edge according to the present invention and frames by three methods, CF, E2VID and E2VID with respect to an image of a girl wearing glasses playing the violin. The bottom row shows the images for frames #1 and #7 for each of ControlNet, CF+ControlVideo and the present invention.

FIG. 8 shows that ControlNet continues to struggle with temporal inconsistency and also fails to produce the correct color (green) in Frame #1 of the second row. On the other hand, ControlVideo does not generate any meaningful content. Like FIG. 5, the top row of FIG. 6 shows event streams #1 and #7, an edge according to the present invention and frames by three methods for a blue sofa in a house. The second and third rows show the images for frames #1and #7for each of ControlNet, CF+ControlVideo and the present invention for a green sofa in a house and a modern sofa in a house, respectively.

In FIG. 9, the first row again shows event streams #1 and #7, an edge according to the present invention and frames by the three methods. FIG. 9 highlights the unnatural image quality produced by ControlNet and various issues in the ControlVideo results, such as non-compliance with the prompt (cartoon) in the second row, indiscernible images in the third row, and structural discrepancies with the event data in the fourth row (differing facial orientations). The prompt for the second row is “An old man wearing glasses, cartoon. For the third and fourth row the prompt is the same, except for laughing and oil painting. As clearly seen from the last two images on each of the second, third and fourth rows of FIG. 9, CUBE produces the clearest and most accurate images.

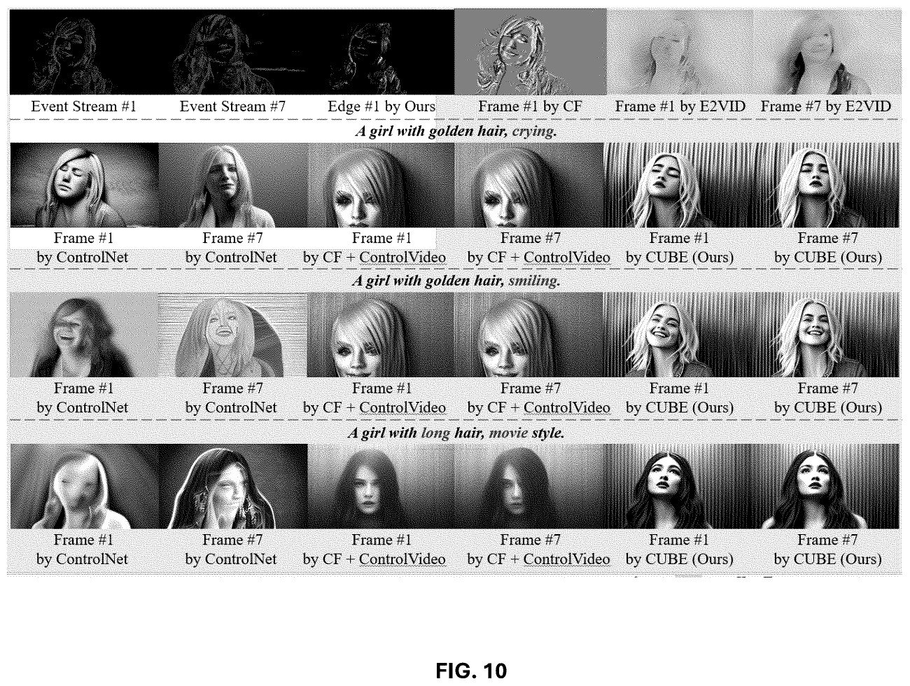

The first row of FIG. 10, as in FIGS. 5, 6 and 7 shows the event streams #1 and #7, an edge according to the present invention and frames by three methods. The prompts for the second, third and fourth rows are “a girl with golden hair, crying”, “a girl with golden hair, smiling” and “a girl with long hair, movie style,” respectively. In FIG. 10 the output of ControlNet appears unnatural with inconsistent frames, and the results of ControlVideo do not align with the event data. In contrast, CUBE generates videos with better video quality, temporal consistency and textual alignment.

CUBE was also compared with other methods quantitatively in 105 video-prompt pairs. As shown in Table 1, CUBE consistently outperformed the base lines in terms of frame and prompt consistency and aligning with qualitative findings. Despite utilizing the same edges, ControlNet demonstrated worse frame consistency than CUBE.

TABLE 1
Quantitative comparisons of CUBE with other methods.

| | Structure | Frame | Prompt |
|---|---|---|---|
| Method | Condition | Consistency (%) | Consistency (%) |
| ControlNet | Edge by Ours | 84.52 | 21.47 |
| ControlVideo | Edge by CF | 90.03 | 23.62 |
| CUBE (Ours) | Edge by Ours | 92.27 | 27.74 |

To further validate the CUBE framework, a user study was conducted. Participants were presented with visualizations of event streams, associated text prompts, and videos synthesized by two distinct methods, presented in random order. They were asked to judge the videos based on three criteria: (i) overall video quality, (ii) temporal consistency across all frames, and (iii) alignment between the text prompts and the synthesized videos. The evaluation set consisted of 105 event-prompt pairs, and each pair was assessed by 5 independent raters. From Table 2, it can be seen that CUBE generated videos were preferred across all three metrics. In contrast, ControlNet struggled to produce videos that were both consistent and of high quality, while ControlVideo also fell short in terms of video quality and consistency.

TABLE 2

| | Video | Temporal | Textual |
|---|---|---|---|
| Method Comparison | Quality | Consistency (%) | Alignment (%) |
| CUBE (Ours) vs. | 85.9 | 100 | 83.1 |
| ControlNet | | | |
| CUBE (Ours) vs. CF + | 78.2 | 59.6 | 76.2 |
| ControlVideo | | | |

To demonstrate the effectiveness of the edge extraction module, a comparison was conducted with the variant of ControlVideo. For this variant, frames reconstructed by CF were used as input edge conditions for ControlVideo. However, as depicted in FIGS. 7-10, the CUBE edge extraction module demonstrated superior integration with ControlVideo, resulting in improved outcomes.

The efficacy of the CUBE video generation process was evaluated against a variant of ControlNet. Utilizing CUBE's extracted edges as structural information, it is evident from FIGS. 7-10 that ControlNet struggles to maintain temporal consistency. This observation validates the choice of ControlVideo as the base model for video generation as an effective strategy.

In summary, CUBE is a framework for controllable, unsupervised event-based video generation, which effectively bridges the gap between event cameras and the need for perceptually realistic video synthesis. Combining event-derived edges with textual descriptions, CUBE transcends the limitations of existing methods, offering controllability and superior performance without the requirement of extensive training.

CUBE appears to be the first framework for event-based video reconstruction using a diffusion model. It has a controllable, training-free framework that combines an edge extraction module with an existing diffusion model. This combination facilitates the reconstruction of video from events, leveraging on the controllability of ControlVideo while circumventing the extensive training requirements. Quantitative and qualitative evaluations demonstrate the superior performance of CUBE in video quality, temporal consistency, and textual alignment compared to existing methods.

The above-described CUBE approach is the first attempt to address event-based video generation, which uses event data as conditional input for video synthesis. However, this approach only minimally integrates event data characteristics, as it primarily focuses on preprocessing events to make them compatible with existing video generation frameworks. This results in limited synergy, where the event data and video generation models are merely “stitched” together rather than deeply integrated, thus failing to fully utilize the unique properties of event data for enhanced performance.

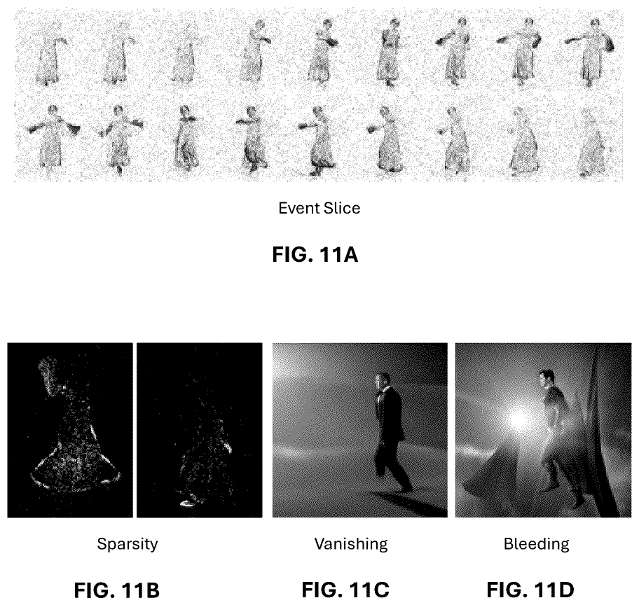

A fundamental limitation in event-based video generation methods is rooted in the inherent sparsity and discontinuity of event data, as illustrated in FIG. 11A, which shows that event cameras capture only pixel changes in areas with motion, leading to flickering and inconsistency. After a denoising process, as shown in FIG. 11B, while the effective events become more apparent, it also exposes the challenges posed by the sparse and fragmented nature of event data as input for video generation models, which typically require continuous and consistent inputs. This sparsity and lack of detail often lead to problems such as joint vanishing as shown in FIG. 11C and texture bleeding as shown in FIG. 11D.

Denoising diffusion probabilistic models (DDPM) [26, 27, 29, 30, 52, 56, 57 are widely used in computer vision, with the latent diffusion model (LDM)[27] offering a more efficient variant by operating in latent space. LDM consist of two stages: encoding, where an encoder compresses an image x into a latent code z=(x), and decoding, where a decoder reconstructs x E(z). The forward process of DDPMs adds Gaussian noise at each step s to produce zs:

$$q ( {z}_{s} \vert {z}_{{s}^{- 1}} ) = N ( {z}_{s} ; \sqrt{1 - {β}_{s}} {z}_{{s}^{- 1}} , {β}_{s} \text{?} ) , \qquad ( 1 )$$

$$\text{?} \text{indicates text missing or illegible when filed}$$

where βs controls the noise scale, and S denotes the total diffusion steps. The reverse process then progressively denoises zs to predict the previous step zs-1:

$$\text{?} ( {z}_{{s}^{- 1}} \vert {z}_{s} ) = N ( {z}_{{s}^{- 1}} ; μ \text{?} ( {z}_{s} , s ) , \text{?} ( {z}_{s} , s ) ) , \qquad ( 2 )$$

$$\text{?} \text{indicates text missing or illegible when filed}$$

where μθ and Σθ are parameterized by a denoising model ne, trained with the objective:

$${L}_{simple} := {E}_{E ( z ) ,} \text{?} ( 0 , 1 ) , s \vert \vert η - η \text{?} ( z , s ) {\vert \vert}_{2}^{2} . \qquad ( 3 )$$

$$\text{?} \text{indicates text missing or illegible when filed}$$

For sample generation, the process starts from zS(0, 1) and applies DDPM sampling to iteratively predict zs-1:

$${z}_{{s}^{- 1}} = \text{?} + \text{?} ( {z}_{s} , s ) , \qquad ( 4 )$$

$${z}^{′} = \frac{{z}_{s} {-}^{√} 1 \text{?} {α}_{s} η \text{?} ( {z}_{s} , s )}{\overline{{α}_{s}}} ,$$

$${Q}_{j = 1} \text{?}$$

$$\text{?} \text{indicates text missing or illegible when filed}$$

where αₛ=^{s}(1 βᵢ). For simplicity, the prediction at step s is denoted as z_{s→0}. The base model is the text-guided Stable Diffusion (SD) η_{θ}(zₛ, s, τ), pre-trained on large-scale image-text pairs, with t representing the text prompt.

In order to overcome the limitations of CUBE, the present invention provides a “CUBE Plus” system that includes two technical innovations that significantly enhance the original CUBE method while remaining within the same inventive framework. These additional innovations include content frame identification and an event-driven attention mechanism. The content frame identification is inspired by the concept of “content words” in natural language processing. The CUBE Plus system selectively identifies and uses only the most information-rich event segments (“content frames”) to drive cross-frame attention. This dramatically improves temporal consistency and computational efficiency while maintaining coherence in video output. The event-driven attention mechanism is a lightweight, event-aware attention module within ControlNet that allows the model to focus on event-dense moments instead of treating all frames equally. This new mechanism outperforms both fully-connected and first-frame-only attention schemes, achieving better video quality and faster generation time. Together, these improvements extend the original CUBE system from a training-free generation pipeline to a more intelligent, event-sparsity-aware, and attention-optimized system.

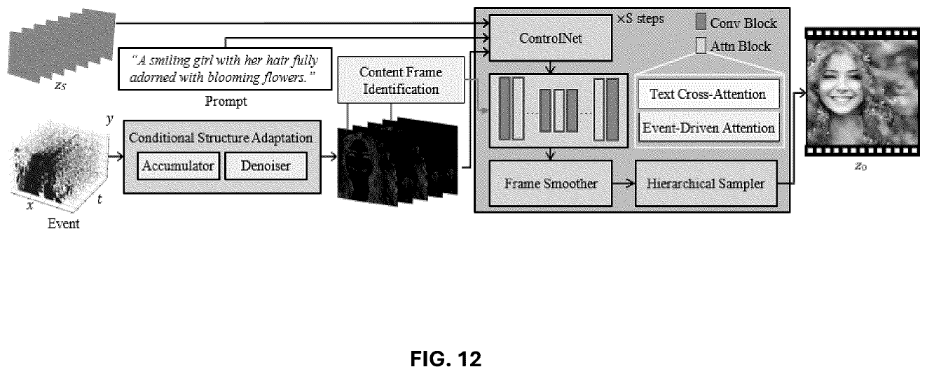

FIG. 12 is a framework overview of a CUBE Plus system that is an improvement over the CUBE system discussed above. FIG. 12 shows this CUBE Plus system with a given input event stream. The system first applies conditional structure adaptation (via an accumulator and denoiser) to make the data compatible. Content frame identification then isolates key frames with dense information, of which latent features are processed in an event-driven attention mechanism within ControlNet [31], alongside text cross-attention, to generate coherent video frames. A frame smoother and hierarchical sampler ensure temporal consistency, resulting in high-quality video output.

As shown in FIG. 12, given an input event stream, conditional structure adaptation is first performed to convert the event data into a compatible format. Then the inherent sparsity and motion sensitivity of the event data is leveraged to optimize video generation, by the co-design of content frame identification and an event-driven attention mechanism. To facilitate an understanding of the improvement, a discussion of the insights and principles behind the invention are next provided.

The conditional structure adaptation can be explained as follows: Given an event stream ϵ={e=(x, y, t, p)}, where each event e; has spatial coordinates (xᵢ, yᵢ), timestamp tᵢ, and polarity pᵢ, the event stream is divided into J temporal segments of length ΔT. For each segment ϵⱼ within the interval [tⱼ, tⱼ+ΔT], the edge map mⱼ is generated by accumulating the contribution of events in that interval:

$$\text{?} ( x , y ) = {\sum }_{{e}_{i} ∈ {ϵ}_{j}} c \cdot \vert δ ( x - {x}_{i} ) δ ( y - \text{?} ) , \qquad ( 5 )$$

$$\text{?} \text{indicates text missing or illegible when filed}$$

where c is the contribution value of each event, typically set to 0.25, and δ represents the Kronecker delta function. The accumulator is configured to ignore polarity, allowing all events to contribute positively and simplifying the edge structure. To address noise commonly found in real event data, a median filter is applied to the edge map

$${\{ \text{?} \}}_{= 1}^{J}$$

$$\text{?} \text{indicates text missing or illegible when filed}$$

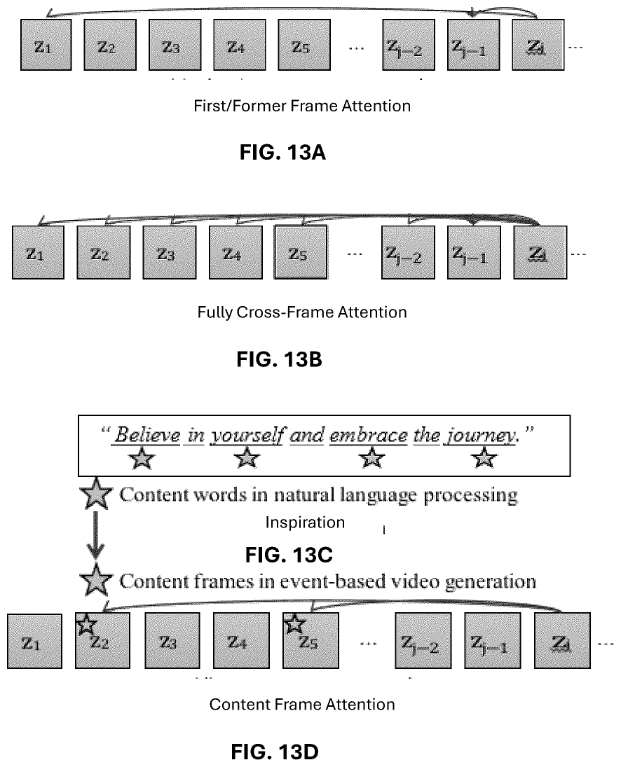

In video generation, directly using existing image generation models like ControlNet [31] to generate frames independently often leads to temporal discontinuity. To address this, prior methods have introduced cross-frame attention mechanisms [58] to enhance frame consistency, generally divided into two types: (i) first/former frame attention [48, 62], as shown in FIG. 13A applies cross-frame attention between the current frame and either the first or previous frame to save computation, but limits continuity and quality due to lack of sufficient context; (ii) fully cross-frame attention [22], as shown in FIG. 13B, which considers all frames together to ensure high continuity across frames but at the cost of substantially increased computational demands.

These conventional attention mechanisms are inherently limited for event-based video generation. The sparsity and discontinuity of event data make it difficult for single-frame attention to capture enough information, while fully cross-frame attention is computationally inefficient and may include redundant or irrelevant frames.

The design of the present invention is inspired by a common mechanism in natural language processing (NLP) [4], as shown in FIG. 13C. In NLP, function words like articles and prepositions contribute little to the main semantic meaning and can often be masked or ignored without impacting overall comprehension. By preselecting only the content words that meaningfully contribute to the core semantics, NLP models can reduce computational demands and focus on the content-rich terms that drive understanding.

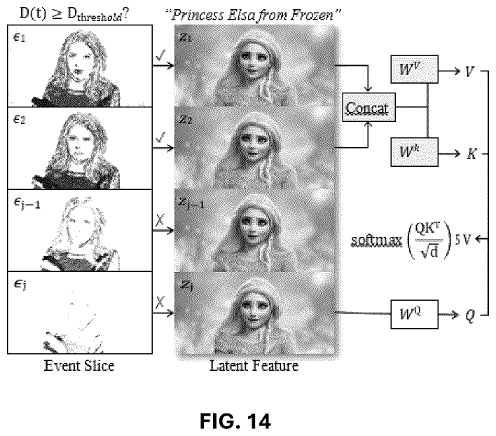

Applying this concept to event data, which is sparse and highly responsive to motion, these properties can be leveraged to identify “content frames”—moments of intense change—and their corresponding frames, as shown in FIG. 13D. This targeted focus not only reduces the computational load of the attention mechanism but also diminishes noise from irrelevant or low-value events, thus preserving output quality. FIG. 14 is an illustration of the event-driven attention mechanism of CUBE Plus. Therefore, in event-based video generation, the primary challenge and guiding principle are: How to leverage the sparsity and motion sensitivity of event data to identify content frames and then compute cross-frame attention accordingly?

With regard to content frame identification, to effectively utilize the sparsity and motion sensitivity of event data, content frames are identified based on event density. For each segment ϵⱼ with time window ΔT, the event density D(t) is computed as follows:

$$D ( t ) = \frac{1}{Δ T} {\sum }_{{e}_{i} ∈ {ϵ}_{j}} r ( \text{?} ) , \qquad ( 6 )$$

$$\text{?} \text{indicates text missing or illegible when filed}$$

where r(eᵢ)=1 if an event eᵢ is present in that window. This density value D(t) serves as a measure of activity over each time segment. If D(t) exceeds a threshold D_{threshold}, then the frames corresponding to this time window are designated as content frames. The threshold is determined by:

$${D}_{threshold} = \frac{1}{2 T} \text{?} D ( t ) dt , \qquad ( 7 )$$

$$\text{?} \text{indicates text missing or illegible when filed}$$

where T is the total duration of the event stream. Thus, for each frame Fⱼ at time t, it is selected as a content frame if:

$$D ( t ) \geq \text{?} . \qquad ( 8 )$$

$$\text{?} \text{indicates text missing or illegible when filed}$$

These selected content frames provide the basis for focused attention in the subsequent module.

Building on the identified content frames, an event-driven attention mechanism is designed that selectively applies cross-frame attention to enhance temporal coherence while minimizing computational overhead. The latent representation of each content frame is used as a feature for cross-frame interactions within the ControlNet model. For each current frame Fⱼ with latent feature zⱼ, the attention weights between the current frame and content frames are computed by:

$$Attention ( Q , K , V ) = \text{?} \frac{{QK}^{T}}{\text{?} \overline{d}} \cdot V , \qquad ( 9 )$$

$$\text{?} \text{indicates text missing or illegible when filed}$$

where Q=W^{Q}Zⱼ, K=W^{K}[Z_{f}] and V={W^{V}}[Z_{f}], with W^{Q}, W^{K}, and W^{V} being weight where matrices, zf are latent features of the content frames, and d is the dimension used for scaling. This attention mechanism effectively prioritizes information from content frames, allowing the model to focus on frames with dense motion information. Analogous to ControlVideo [22], after applying the cross-frame interaction, the clean video latent zs→0 is estimated from zs using the formula:

$${z}_{s \to O} = \frac{{z}_{s} - √ \overline{1 - \text{?}} ( {z}_{s} , s , m , τ )}{\overline{{α}_{s}}} . \qquad ( 10 )$$

$$\text{?} \text{indicates text missing or illegible when filed}$$

The refined latent \ddot{Z}_{s→0} is then obtained in a frame smoother. Following the standard diffusion model approach, starting with a noisy latent Zₛ˜N(0, 1) cleaner latents are iteratively estimated until reaching z₀, as follows:

$${z}_{s - 1} = \text{?} \frac{α}{s - 1} {\hat{z}}_{s \to O} + \text{?} \cdot {η}_{ϑ} ( {z}_{s} , s , m , τ ) , \qquad ( 11 )$$

$$\text{?} \text{indicates text missing or illegible when filed}$$

where αₜ is a noise scaling factor, \hat{z}ₜ is the attention-refined and smoothed video latent for the frame at time t, and η_{θ} is a denoising model conditioned on both the identified content frames and input prompt τ.

The improved framework of CUBE Plus is implemented based on the generative model ControlNet [66], with frame smoother performed using RIFE [32], and the hierarchical sampler adopted from ControlVideo [22]. During sampling, DDIM sampling is used with 50 timesteps, applying an interleaved-frame smoother on the predicted frames at timesteps {19,20}. An efficient implementation of xFormers [33] is utilized. All experiments were conducted on an NVIDIA RTX 4090 GPU.

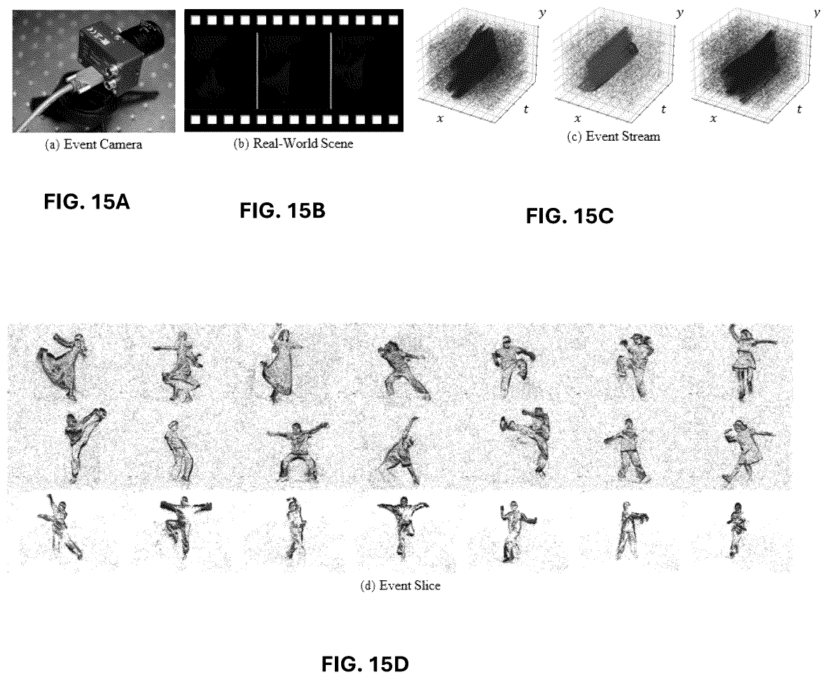

To comprehensively evaluate and compare performance, three different datasets were used, including one simulated dataset and two real-world event camera datasets:
Vimeo. Following CUBE, 25 videos were collected from the Vimeo dataset [34] and their source descriptions were manually annotated. V2E [9] was used to generate events. For each event, 5 textual prompts were written, resulting in a dataset of 125 event-prompt pairs for testing.
EDance. Real-world dance sequences were captured using a DAVIS346 event camera [26] as shown in FIG. 15A. This dataset, named EDance, includes 10 dance styles. In low-light conditions as shown in FIG. 15B, 10 long sequences are recorded for each style, yielding 100 event streams. Additionally, 10 sequences of improvised dance were recorded under normal lighting, mixing elements of various dance styles. In total, the EDance dataset includes 110 sequences. For each data instance, 5 prompts were written, resulting in 550 event-prompt pairs for testing. Examples of event visualizations are shown in FIGS. 15C and 15D. The DAVIS346 event camera features a 346×260 pixel array, a high dynamic range of 120 dB, and microsecond level temporal resolution. These characteristics enable the accurate capture of rapid motion while maintaining robustness against noise, especially under low-light conditions. The camera's ability to asynchronously record brightness changes allows for efficient data collection, ensuring precise motion capture for event-based video generation experiments
EventVOT. Also, a high-resolution real-world event dataset, EventVOT [61], was used. This data set covers diverse scenes and objects. A total of 18 event samples were used from the validation set, with 5 prompts written for each, creating 90 event-prompt pairs for testing.

Following prior works on video generation [48, 22, 62, 65], CLIP was adopted to evaluate video quality from two perspectives:
1) Frame Consistency: the average cosine similarity between all pairs of consecutive frames;
2) Prompt Consistency: the average cosine similarity between the input prompt and all video frames. For comprehensive evaluations, MUSIQ [47], MANIQA [63], CLIP-IQA [60] metrics were additionally adopted.

The CUBE Plus was compared against four event-based reconstruction methods: E2VID [40,54], EVSNN [66], Event-Diffusion [19], and E2VIDiff [49]; and three video generation methods, ControlNet [31], Rerender-A-Video [64] and basic CUBE. Notably, since ControlNet and Rerender-A-Video do not natively support event stream input, events for those methods were preprocessed using the conditional structure adaptation module of the present invention before inputting to ControlNet and Rerender-A-Video. CUBE is the only other method for event-based controllable video generation.

A user study was conducted to assess video quality. Specifically, each of 11 raters was provided with a structure sequence, a text prompt, and synthesized videos from two different methods (presented in random order). They were then asked to select the video with better quality. Each rater was shown a total of 6 pairs of video generation results in random order: 3 pairs comparing with CUBE Plus with CUBE and another 3 pairs comparing our CUBE Plus with ControlNet. For each pair, the raters were instructed to select the video they found visually superior based on realism, temporal consistency, and alignment with the input prompts. In total, each pair was evaluated by all 11 raters, leading to 33 comparisons between CUBE Plus method and CUBE, and 33 comparisons between CUBE Plus and ControlNet. The voting results were tabulated and are summarized in Table 4.

Table 3 and Table 4 compare the method of the CUBE Plus system with various event-based reconstruction and generation approaches across three datasets: Vimeo, EDance, and EventVOT.

TABLE 3

| Dataset | | Vimeo | | | EDance | | | EventVOT | | |
|---|---|---|---|---|---|---|---|---|---|---|
| Type | Method | MUSIQ | MANIQA | CLIP-IQA | MUSIQ | MANIQA | CLIP-IQA | MUSIQ | MANIQA | CLIP-IQA |
| Event-Based | E2VID | 43.4190 | 0.3585 | 0.4378 | 41.8432 | 0.2927 | 0.3277 | 53.3209 | 0.4402 | 0.4579 |
| Reconstruction | EVSNN | 47.0502 | 0.3339 | 0.5187 | 26.7439 | 0.1611 | 0.4275 | 45.5366 | 0.4814 | 0.3581 |
| | EZVIDiff | 42.5570 | 0.2507 | 0.3367 | 38.9776 | 0.2003 | 0.2062 | 54.1543 | 0.4780 | 0.4231 |
| | Event-Diffusion | 34.4119 | 0.2257 | 0.3299 | 36.3862 | 0.1958 | 0.4222 | 51.9490 | 0.3115 | 0.4254 |
| Event-Based | ControlNet | 57.6950 | 0.3632 | 0.4375 | 47.6038 | 0.2321 | 0.4646 | 52.5263 | 0.4435 | 0.4329 |
| Generation | Rerender-A-Video | 59.3492 | 0.4287 | 0.5707 | 39.5866 | 0.2129 | 0.3801 | 61.1326 | 0.3687 | 0.5616 |
| | CUBE | 60.3228 | 0.4762 | 0.5932 | 51.6868 | 0.3851 | 0.4836 | 54.0806 | 0.4970 | 0.6812 |
| | Ours | 62.0846 | 0.5027 | 0.6954 | 57.5863 | 0.4382 | 0.5280 | 65.2756 | 0.6127 | 0.7032 |

In particular Table 3 shows a comparison across various event-based reconstruction and generation methods on three datasets: Vimeo [34], EDance, and EventVOT [61]. Frame consistency measures the average similarity between consecutive frames, while prompt consistency evaluates alignment with textual prompts. The best results are highlighted in red, while the second-best results are highlighted in blue

TABLE 4

| Dataset | | Vimeo | | EDance | | EventVOT | |
|---|---|---|---|---|---|---|---|
| Type | Method | Frame (%) | Prompt (%) | Frame (%) | Prompt (%) | Frame (%) | Prompt (%) |
| Event-Based | E2VID | 92.72 | — | 97.51 | — | 98.05 | — |
| \|Reconstruction | EVSNN | 90.62 | — | 94.85 | — | 94.97 | — |
| | EZVIDiff | 93.60 | — | 98.10 | — | 98.29 | — |
| | Event-Diffusion | 93.85 | — | 98.14 | — | 98.34 | — |
| Event-Based | ControlNet | 70.12 | 26.29 | 77.15 | 31.07 | 77.69 | 25.86 |
| Generation | Rerender-A-Video | 96.45 | 27.10 | 95.61 | 31.18 | 96.69 | 21.74 |
| | CUBE | 98.16 | 26.27 | 97.46 | 28.00 | 98.19 | 24.40 |
| | Ours | 98.25 | 29.91 | 98.97 | 36.74 | 98.83 | 27.20 |

CUBE Plus (Ours in the table) achieves the highest frame and prompt consistency scores across all datasets, highlighted in red, showcasing superior temporal coherence and prompt alignment. Table 5 shows user study results indicating a strong preference for the CUBE Plus approach, with 100% favoring it over ControlNet, 96.97% favoring it over Rerender-A-Video and 93.94% over basic CUBE, highlighting the effectiveness of CUBE Plus in enhancing video quality.

TABLE 5

| Comparison | Ours vs. ControlNet | vs. R-A-V | vs. CUBE |
|---|---|---|---|
| Video Quality | 100% | 96.97% | 93.94% |

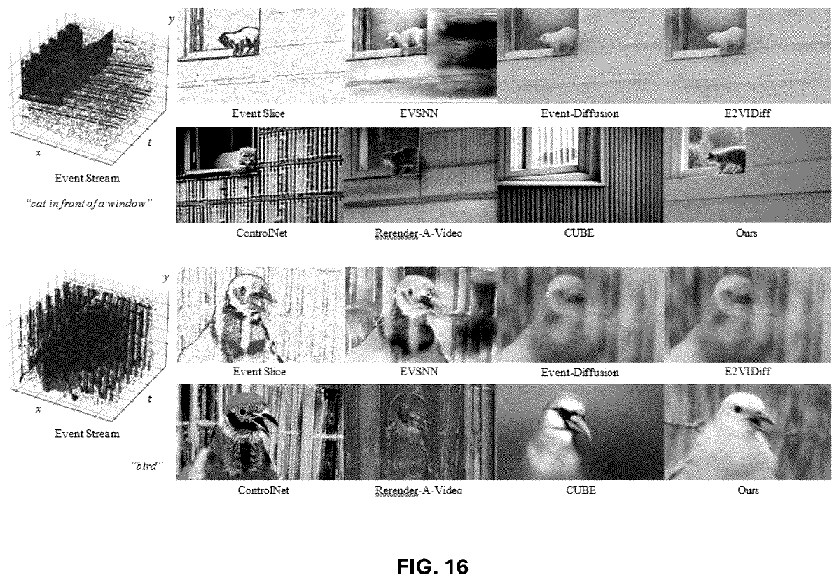

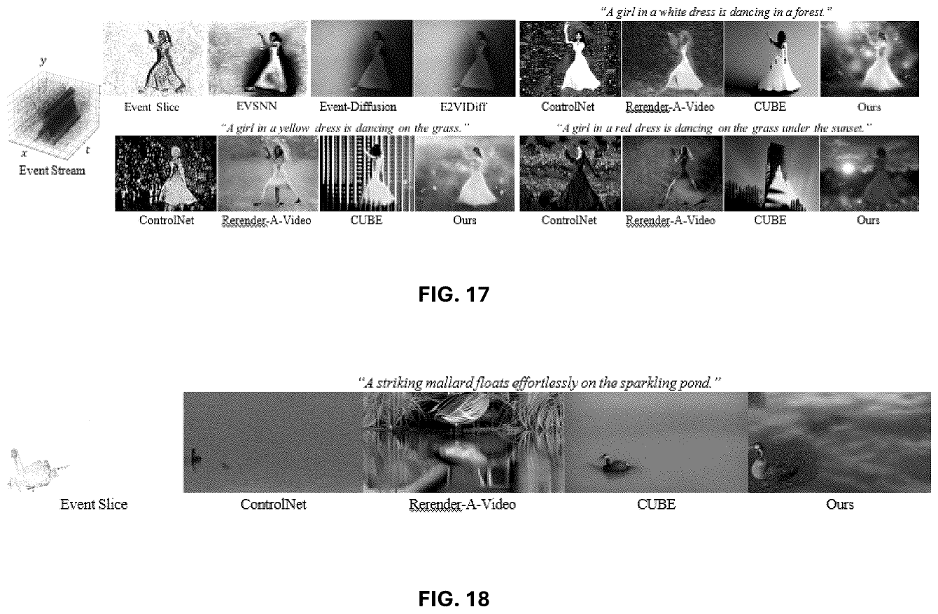

FIGS. 16, 17 and 18 present further qualitative comparisons. On the Vimeo dataset (FIG. 16), reconstruction methods yield blurred images, ControlNet and Rerender-A-Video produce unrealistic frames, and original or basic CUBE shows texture vanishing. On the EDance dataset (FIG. 17), severe noise leads to rough contours in reconstruction methods, while ControlNet and Rerender-A-Video appear unrealistic, and basic CUBE inconsistently aligns with text prompts. CUBE Plus generates frames closely matching textual prompts. On the EventVOT dataset (FIG. 18), ControlNet suffers from texture vanishing, and Rerender-A-Video and basic CUBE fail to match input structures, while CUBE Plus delivers realistic and coherent outputs across scenarios.

To evaluate the event-driven attention of CUBE Plus, it was compared with three variants: (i) Individual (no interaction), (ii) First-Only (only to the first frame), and (iii) Fully (all frames attend to each other).

TABLE 6

| Attention | Frame (%) | Prompt (%) | Time (sec) |
|---|---|---|---|
| Individual | 74.99 | 27.74 | 29 |
| First-Only | 96.46 | 26.29 | 30 |
| Fully | 98.53 | 31.25 | 75 |
| Ours | 98.68 | 31.28 | 37 |

As shown in Table 6, the CUBE Plus (Ours) method achieves the highest frame (98.68%) and prompt (31.28%) consistency, compared to the Fully with frame consistency (98.53%) and expensive computation (75 s), with almost half the time (37 s), demonstrating both efficiency and effectiveness.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[1] Christian Brandli et al., “A 240×180 130 db 3 μs latency global shutter spatiotemporal vision sensor,” IEEE Journal of Solid-State Circuits, vol. 49, no. 10, pp. 2333-2341, 2014.
[2] Shuo Zhu et al., “Computational neuromorphic imaging: principles and applications,” in Computational Optical Imaging and Artificial Intelligence in Biomedical Sciences, 2024, vol. 12857.
[3] Chutian Wang et al., “Tracking the shack-hartmann spots using neuromorphic motion compensation,” in Computational Optical Sensing and Imaging, 2023, pp. CTu2B-5.
[4] Shuo Zhu et al., “Removing wall redundancy in non-line-of-sight object-tracking using neuromorphic imaging,” in Computational Optical Sensing and Imaging, 2023, pp. CTu2B-6.
[5] Pei Zhang et al., “Event encryption: Rethinking privacy exposure for neuromorphic imaging,” Neuromorphic Computing and Engineering, vol. 4, no. 1, pp. 014002 (1-8), January 2024.
[6] Guillermo Gallego et al., “Event-based vision: A survey,” IEEE transactions on pattern analysis and machine intelligence, vol. 44, no. 1, pp. 154-180, 2020.
[7] Patrick Bardow et al., “Simultaneous optical flow and intensity estimation from an event camera,” in the IEEE conference on computer vision and pattern recognition, 2016, pp. 884-892.
[8] Gottfried Munda et al., “Real-time intensity-image reconstruction for event cameras using manifold regularisation,” International Journal of Computer Vision, vol. 126, pp. 1381-1393, 2018.
[9] Henri Rebecq et al., “Evo: A geometric approach to event-based 6-dof parallel tracking and mapping in real time,” IEEE Robotics and Automation Letters, vol. 2, no. 2, pp. 593-600, 2016.
[10] Henri Rebecq et al., “High speed and high dynamic range video with an event camera,” IEEE transactions on pattern analysis and machine intelligence, vol. 43, no. 6, pp. 1964-1980, 2021.
[11] Cedric Scheerlinck et al., “Fast image reconstruction with an event camera,” in the IEEE/CVF Winter Conference on Applications of Computer Vision, 2020, pp. 156-163.
[12] Timo Stoffregen et al., “Reducing the sim-to-real gap for event cameras,” in ECCV 2020, Part XXVII 16, 2020, pp. 534-549.
[13] Lin Wang et al., “Event-based high dynamic range image and very high frame rate video generation using conditional generative adversarial networks,” in the IEEE/CVF Conference on Computer Vision and Pattern Recognition, 2019, pp. 10081-10090.
[14] Wenming Weng et al., “Event-based video reconstruction using transformer,” in the IEEE/CVF International Conference on Computer Vision, 2021, pp. 2563-2572.
[15] Yunhao Zou et al., “Learning to reconstruct high speed and high dynamic range videos from events,” in the IEEE/CVF Conference on Computer Vision and Pattern Recognition, 2021, pp. 2024-2033.
[16] Jonghyun Choi et al., “Learning to super resolve intensity im-ages from events,” in the IEEE/CVF Conference on Computer Vision and Pattern Recognition, 2020, pp. 2768-2776.
[17] Bishan Wang et al., “Event enhanced high-quality image recovery,” in ECCV 2020, Part XIII 16, 2020, pp. 155-171.
[18] Lin Wang et al., “Eventsr: From asynchronous events to image reconstruction, restoration, and super-resolution via end-to-end adversarial learning,” in the IEEE/CVF Conference on Computer Vision and Pattern Recognition, 2020, pp. 8315-8325.
[19] Quanmin Liang et al., “Event-diffusion: Event-based image reconstruction and restoration with diffusion models,” in the 31st ACM International Conference on Multimedia, 2023, pp. 3837-3846.
[20] Hengyuan Ma et al., “Accelerating score-based generative models with preconditioned diffusion sampling,” in European Conference on Computer Vision, 2022, pp. 1-16.
[21] Elias Mueggler et al., “The event-camera dataset and simulator: Event-based data for pose estimation, visual odometry, and slam,” The International Journal of Robotics Research, vol. 36, no. 2, pp. 142-149, 2017.
[22] Yabo Zhang et al., “Controlvideo: Training-free controllable text-to-video generation,” International Conference on Learning Representations (ICLR), 2024.
[23] Pei Zhang et al., “Neuromorphic imaging with density-based spatiotemporal denoising,” IEEE Transactions on Computational Imaging, vol. 9, pp. 530-541, May 2023.
[24] Pei Zhang et al., “Neuromorphic imaging and classification with graph learning,” Neurocomputing, vol. 565, pp. 127010 (1-9), January 2024.
[25] Pei Zhang et al., “Neuromorphic imaging with joint image deblurring and event denoising,” arXiv preprint arXiv: 2309.16106, 2023.
[26] Jonathan Ho et al., “Denoising diffusion probabilistic models,” Advances in neural information processing systems, vol. 33, pp. 6840-6851, 2020.
[27] Robin Rombach et al., “High-resolution image synthesis with latent diffusion models,” in the IEEE/CVF conference on computer vision and pattern recognition, 2022, pp. 10684-10695.
[28] Jascha Sohl-Dickstein et al., “Deep unsupervised learning using nonequilibrium thermodynamics,” International conference on machine learning, 2015, pp. 2256-2265.
[29] Yang Song and Stefano Ermon, “Generative modeling by estimating gradients of the data distribution,” Advances in neural information processing systems, vol. 32, 2019.
[30] Yang Song et al., “Score-based generative modeling through stochastic differential equations,” arXiv preprint arXiv: 2011.13456, 2020.
[31] Lvmin Zhang et al., “Adding conditional control to text-to-image diffusion models,” in the IEEE/CVF International Conference on Computer Vision, 2023, pp. 3836-3847.
[32] Zhewei Huang et al., “Real-time intermediate flow estimation for video frame interpolation,” in European Conference on Computer Vision, 2022, pp. 624-642.
[33] Benjamin Lefaudeux et al., “xformers: A modular and hackable transformer modelling library,” 2021.
[34] Tianfan Xue et al., “Video enhancement with task-oriented flow,” International Journal of Computer Vision, vol. 127, pp. 1106-1125, 2019.
[35] Yuhuang Hu, Shih-Chii Liu, and Tobi Delbruck, “v2e: From video frames to realistic dvs events,” in the IEEE/CVF Conference on Computer Vision and Pattern Recognition, 2021, pp. 1312-1321.
[36] Patrick Esser et al., “Structure and content-guided video synthesis with diffusion models,” in the IEEE/CVF International Conference on Computer Vision, 2023, pp. 7346-7356.
[37] Jay Zhangjie Wu et al., “Tune-a-video: One-shot tuning of image diffusion models for text-to-video generation,” in the IEEE/CVF International Conference on Computer Vision, 2023, pp. 7623-7633.
[38] Alec Radford et al., “Learning transferable visual models from natural language supervision,” International conference on machine learning, 2021, pp. 8748-8763.
[39] Cedric Scheerlinck, Nick Barnes, and Robert Mahony, “Continuous-time intensity estimation using event cameras,” in Asian Conference on Computer Vision, 2018, pp. 308-324.
[40] Henri Rebecq et al., “Events-to-video: Bringing modern computer vision to event cameras,” in the IEEE/CVF Conference on Computer Vision and Pattern Recognition, 2019, pp. 3857-3866.
[41] DAVIS346. https://invitation.com/wp-content/uploads/2019/08/DAVIS346.pdf. Ac-cessed: 2024 Jun. 29. 6.
[42] Pablo Rodrigo Gantier Cadena, Yeqiang Qian, Chunxiang Wang, and Ming Yang. Spade-e2vid: Spatially-adaptive de-normalization for event-based video reconstruction. IEEE Transactions on Image Processing, 30:2488-2500, 2021. 2.
[43] Guang Chen, Hu Cao, Jorg Conradt, Huajin Tang, Florian Rohrbein, and Alois Knoll. Event-based neuromorphic vision for autonomous driving: A paradigm shift for bio-inspired visual sensing and perception. IEEE Signal Pro-cessing Magazine, 37(4):34-49, 2020. 2.
[44] KR1442 Chowdhary and KR Chowdhary. Natural language processing. Fundamentals of artificial intelligence, pages 603-649, 2020. 4.
[45] Daniel Gehrig, Henri Rebecq, Guillermo Gallego, and Da-vide Scaramuzza. Asynchronous, photometric feature tracking using events and frames. In Proceedings of the European Conference on Computer Vision (ECCV), pages 750-765, 2018. 2.
[46] Mathias Gehrig, Willem Aarents, Daniel Gehrig, and Davide Scaramuzza. Dsec: A stereo event camera dataset for driving scenarios. IEEE Robotics and Automation Letters, 6(3): 4947-4954, 2021. 2.
[47] Junjie Ke, Qifei Wang, Yilin Wang, Peyman Milanfar, and Feng Yang. MUSIQ: Multi-scale image quality transformer. In Proceedings of the IEEE/CVF international conference on computer vision, pages 5148-5157, 2021. 7.
[48] Levon Khachatryan, Andranik Movsisyan, Vahram Tade-vosyan, Roberto Henschel, Zhangyang Wang, Shant Navasardyan, and Humphrey Shi. Text2video-zero: Text-to-image diffusion models are zero-shot video generators. In Proceedings of the IEEE/CVF International Conference on Computer Vision, pages 15954-15964, 2023. 4, 7.
[49] Jinxiu Liang, Bohan Yu, Yixin Yang, Yiming Han, and Boxin Shi. E2vidiff: Perceptual events-to-video reconstruction using diffusion priors. arXiv preprint arXiv:2407.08231, 2024. 2, 3, 7.
[50] Ana I Maqueda, Antonio Loquercio, Guillermo Gallego, Narciso Garcia, and Davide Scaramuzza. Event-based vision meets deep learning on steering prediction for self-driving cars. In Proceedings of the IEEE conference on computer vision and pattern recognition, pages 5419-5427, 2018. 2.
[51] Anton Mitrokhin, Cornelia Fermuller, Chethan Parameshwara, and Yiannis Aloimonos. Event-based moving object detection and tracking. In 2018 IEEE/RSJ International Conference on Intelligent Robots and Systems (IROS), pages 1-9. IEEE, 2018. 2.
[52] Alexander Quinn Nichol and Prafulla Dhariwal. Improved denoising diffusion probabilistic models. In International conference on machine learning, pages 8162-8171. PMLR, 2021. 2, 3.
[53] Federico Paredes-Valle's and Guido CHE De Croon. Back to event basics: Self-supervised learning of image reconstruction for event cameras via photometric constancy. In Proceedings of the IEEE/CVF Conference on Computer Vision and Pattern Recognition, pages 3446-3455, 2021. 2, 3.
[54] Henri Rebecq, Rene'Ranftl, Vladlen Koltun, and Davide Scaramuzza. High speed and high dynamic range video with an event camera. IEEE Trans. Pattern Anal. Mach. Intell. (T-PAMI), 2019. 2, 3, 7.
[55] Olaf Ronneberger, Philipp Fischer, and Thomas Brox. U-Net: Convolutional networks for biomedical image segmentation. In Medical image computing and computer-assisted intervention-MICCAI 2015: 18th international conference, Munich, Germany, Oct. 5-9, 2015, proceedings, part III 18, pages 234-241. Springer, 2015. 3.
[56] Jascha Sohl-Dickstein, Eric Weiss, Niru Maheswaranathan, and Surya Ganguli. Deep unsupervised learning using nonequilibrium thermodynamics. In International conference on machine learning, pages 2256-2265. PMLR, 2015. 2, 3.
[57] Jiaming Song, Chenlin Meng, and Stefano Ermon. Denoising diffusion implicit models. arXiv preprint arXiv:2010.02502, 2020. 6.
[58] Ashish Vaswani, Noam Shazeer, Niki Parmar, Jakob Uszkoreit, Llion Jones, Aidan N. Gomez, Lukasz Kaiser, and Illia Polosukhin. Attention is all you need, 2023. 4.
[59] Antoni Rosinol Vidal, Henri Rebecq, Timo Horstschaefer, and Davide Scaramuzza. Ultimate slam? combining events, images, and imu for robust visual slam in hdr and high-speed scenarios. IEEE Robotics and Automation Letters, 3(2):994-1001, 2018. 2.
[60] Jianyi Wang, Kelvin C K Chan, and Chen Change Loy. Exploring clip for assessing the look and feel of images. In Proceedings of the AAAI conference on artificial intelligence, pages 2555-2563, 2023. 7.
[61] Xiao Wang, Shiao Wang, Chuanming Tang, Lin Zhu, Bo Jiang, Yonghong Tian, and Jin Tang. Event stream-based visual object tracking: A high-resolution benchmark dataset and a novel baseline. In Proceedings of the IEEE/CVF Conference on Computer Vision and Pattern Recognition, pages 19248-19257, 2024. 6, 7, 8.
[62] Jay Zhangjie Wu, Yixiao Ge, Xintao Wang, Stan Weixian Lei, Yuchao Gu, Yufei Shi, Wynne Hsu, Ying Shan, Xiaohu Qie, and Mike Zheng Shou. Tune-a-video: One-shot tuning of image diffusion models for text-to-video generation. In Proceedings of the IEEE/CVF International Conference on Computer Vision, pages 7623-7633, 2023. 4, 7.
[63] Sidi Yang, Tianhe Wu, Shuwei Shi, Shanshan Lao, Yuan Gong, Mingdeng Cao, Jiahao Wang, and Yujiu Yang. MANIQA: Multi-dimension attention network for no-reference image quality assessment. In Proceedings of the IEEE/CVF conference on computer vision and pattern recognition, pages 1191-1200, 2022. 7.
[64] Shuai Yang, Yifan Zhou, Ziwei Liu, and Chen Change Loy. Rerender a video: Zero-shot text-guided video-to-video translation. In SIGGRAPH Asia 2023 Conference Papers, pages 1-11, 2023. 7.
[65] Yaping Zhao, Pei Zhang, Chutian Wang, and Edmund Y Lam. Controllable unsupervised event-based video generation. In 2024 IEEE International Conference on Image Pro-cessing (ICIP), pages 2278-2284. IEEE, 2024. 2, 3, 7.
[66] Lin Zhu, Xiao Wang, Yi Chang, Jianing Li, Tiejun Huang, and Yonghong Tian. Event-based video reconstruction via potential-assisted spiking neural network. In Proceedings of the IEEE/CVF Conference on Computer Vision and Pattern Recognition, pages 3594-3604, 2022. 3, 7.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A video generation framework that is controllable, unsupervised, and based on events (CUBE) comprising:
an event camera, which captures changes in light intensity at each pixel of a scene asynchronously and generates event camera data;
an edge extraction module that translates event data into a format usable by text-to-image diffusion models, and
a text-to-image diffusion model that is conditioned on textual descriptions and which integrates the event camera data to control video synthesis;
whereby the diffusion model generates detailed and contextually accurate videos based on textual prompts.

2. The video generation framework according to claim 1 wherein the text-to image diffusion model is ControlVideo, and to facilitate the integration of an event stream with ControlVideo, the edge extraction module converts events into edges.

3. A method of generating videos that is controllable, unsupervised and based on events comprising the steps of:
capturing changes in light intensity at each pixel of a scene asynchronously and generating an event data stream therefrom;
synthesizing video by segmenting the event data stream into bins, each holding n events;
extracting an edge map from the bins in the form of an intensity image; and
integrating the event data stream into a text-to-image diffusion model that is conditioned on textual descriptions using an edge extraction module to convert events into edges.

4. The method of claim 3 wherein the text-to image diffusion model is ControlVideo, and to facilitate the integration of an event stream with ControlVideo, the edge extraction module converts events into edges.

5. The method of claim 4 wherein the extraction of the edge map is based on as the Kronecker delta function.

6. The method of claim 4 wherein the controllable event-based video generation produces a V-length video by leveraging both the extracted edge information and a textual prompt.

7. The method of claim 6 further comprises the steps of:
creating a clean video latent;
mapping the clean video latent to RGB video;
smoothing the RGB video by employing an interleaved-frame technique; and
using the smoother RGB video to deduce a less noisy latent video following the DDIM denoising process.

8. The method of claim 7 whereby videos of both 7-frame and 100-frame lengths are produced in about 0.5 and 5 minutes, respectively.

9. The method of claim 8 using a single NVIDIA RTX 4090 processor.

10. The video generation framework according to claim 1 further comprising:
a content frame identification module which selectively identifies and uses only the most information-rich event segments of the event camera data to drive cross-frame attention; and
an event driven attention mechanism that allows the framework to focus on event-dense moments.

11. The video generator framework of claim 10 further comprising a conditional structure adaptation to make the data compatible and a content frame identification module that isolates key frames with dense information, of which latent features are processed in said event-driven attention mechanism alongside text cross-attention, to generate coherent video frames.

12. The video generation framework according to claim 11, the conditional structure adaptation is achieved via an accumulator and denoiser and the content frame mechanism is achieved within ControlNet.

13. The video generation framework according to claim 11 further comprising a frame smoother and hierarchical sampler located after the event-driven attention mechanism to ensure temporal consistency, resulting in high-quality video output.

14. The method of claim 3 further comprising the steps of;
causing a content frame identification module to selectively identify and use only the most information-rich event segments of the event camera data to drive cross-frame attention; and
using an event driven attention mechanism to allow the framework to focus on event-dense moments.

15. The method of claim 14 further comprising the steps of:
preprocessing the event data stream with a conditional structure adaptation to make the data compatible and using a content frame identification module to isolate key frames with dense information, of which latent features are processed in said event-driven attention mechanism alongside text cross-attention, to generate coherent video frames.

16. The method of claim 14 further comprising the steps of: applying a frame smoother and hierarchical sampler to the output of the event-driven attention mechanism to ensure temporal consistency, resulting in high-quality video output.
